(19) United States
(12) Patent Application Publication
(10) Pub. No.: US 2017/0096223 A1
(43) Pub. Date: Apr. 6, 2017

(54) AIRCRAFT PYLON

(71) Applicant: ISRAEL AEROSPACE INDUSTRIES LTD., Lord (IL)

(72) Inventor: Yoav Herzig, Ein Sarid (IL)

(21) Appl. No.: 15/128,169

(22) PCT Filed: Mar. 22, 2015
(86) PCT No.: PCT/IL2015/050298

§ 371 Date: Sep. 22, 2016

(30) Foreign Application Priority Data
Mar. 23, 2014 (IL) 231653

(51) Int. Cl. B64D 1/08; B64D 27/26; B64C 1/14

(52) U.S. Cl. CPC B64D 1/08; B64C 1/1415; B64D 27/26

(57) ABSTRACT

An aircraft pylon comprising a body for mounting to an aircraft, a suspension mechanism mounted on said body and being configured for attaching thereto a payload, and a moving door configured for selectively covering and uncovering at least a part of said suspension mechanism

### TECHNOLOGICAL FIELD

The presently disclosed subject matter relates to an aircraft pylon in general and in particular to an aircraft pylon having a suspension mechanism.

### BACKGROUND

Aircraft pylon is a suspension device externally installed under the wing or fuselage of an aircraft. The aircraft pylon provides means of externally attaching fuel tanks, or other external payloads to the aircraft.

The aircraft pylons can be installed in both civil and military aircrafts so as to allow external carrying of engines, weapons, and fuel tanks. The presence of pylons however may affect the aerodynamic characteristics of the aircraft such as a loss of wing lift. In order to reduce the aerodynamic consequences, the pylon can be aerodynamically designed to fit the configuration of specific aircraft so as to create the least amount of drag

U.S. Pat. No. 4,867,394 for example discloses a pylon shaped in such a way as to reduce the drag and loss of wing lift within the fuselage-wing-pylon nacelle channel of an aircraft without creating additional drag associated with other areas of the pylon.

### GENERAL DESCRIPTION

There is provided according to an aspect of the presently disclosed subject matter an aircraft pylon comprising a body for mounting to an aircraft, a suspension mechanism mounted on the body and being configured for attaching thereto payload, and a moving door configured for selectively covering and uncovering at least a part of the suspension mechanism.

The moving door can include an outer surface having a shape optimized to have pre-determined exterior interaction conforming to corresponding exterior interaction of the body. The corresponding exterior interaction of the body conforms to an exterior interaction of the aircraft. The exterior interaction can be one or more of the following: aerodynamic drag, aerodynamic noise, radar emission, IR emission.

The exterior interaction can include at least one parameter exterior to the aircraft which effects the operation of the aircraft in view of the intended use thereof.

The moving door can be configured for selectively shifting between a closed position, in which at least a part of the suspension mechanism is covered, and an open position wherein a payload can be secured to the suspension mechanism. In the closed position the body and the moving door can be configured to form together a homogenous structure configured to provide a homogenous exterior interaction.

The aircraft pylon can further comprise coupling means configured for releasably mounting of the body to an aircraft.

The suspension mechanism can comprise securing elements configured to be secured to a corresponding securing elements provided on the payload. The suspension mechanism can be configured for an automatic releasing of the payload.

The moving door can be configured to cover at least portions of the suspension mechanism form an undesired exterior interaction. Alternatively, the moving door can be configured to cover the entire suspension mechanism. The moving door can be configured to cover the suspension mechanism together with the payload secured thereto. The moving door can include two wings, configured to pivot along the body.

The moving door can be a single door pivoting along the body. Alternatively, the moving door can be a sliding door configured such that the suspension mechanism is selectively covered or uncovered. According to an example, the moving door can be a folding door configured to fold away from the suspension mechanism such that the payload can be secured thereto.

According to another aspect of the presently disclosed subject matter there is provided an aircraft comprising an aircraft body, a pylon having a pylon body for mounting to the aircraft body, a suspension mechanism mounted on the pylon body and being configured for attaching thereto a payload, and a moving door configured for selectively covering and uncovering at least a part of the suspension mechanism.

The aircraft body can be configured with an optimized shape having a predetermined exterior interaction and the moving door can include an outer surface having a shape optimized to have predetermined corresponding exterior interaction conforming to the exterior interaction of the aircraft body.

The exterior interaction can be one or more of the following: aerodynamic drag, aerodynamic noise, radar emission, IR emission.

The moving door can be configured for selectively shifting between a closed position, in which at least a part of the suspension mechanism is covered, and an open position, in which a payload can be secured to the suspension mechanism. In the closed position the pylon body and the moving door form together a structure being homogenous with the aircraft body and being configured to provide a homogenous exterior interaction therewith.

The aircraft can include a first mode, wherein the moving doors are opened, and payload can be secured to the suspension mechanism, and a second mode wherein the moving doors are closed, and the aircraft body together with the pylon body and the moving door provide an optimized shape with regards to the exterior interactions.

According to yet another aspect of the presently disclosed subject matter there is provided a method for optimizing a shape of an aircraft body, the method comprising: optimizing a shape of an aircraft body in view of the intended use thereof; selecting a pylon, having a pylon body for mounting to the aircraft body, selecting a suspension mechanism for mounting on the pylon body being configured for attaching thereto a payload; selecting a moving door configured for selectively covering and uncovering at least a part of the suspension mechanism; and optimizing the shape of the pylon body and the moving door in view of the intended use of the aircraft.

The method can further include determining the materials of which the pylon body is made

Optimizing the shape of the aircraft body can include selecting an outer surface configured for a predetermined exterior interaction, and wherein the step of optimizing the shape of the pylon body and the moving door includes selecting an outer surface configured for a corresponding predetermined exterior interaction conforming to the exterior interaction of the aircraft body.

The exterior interaction can be one or more of the following: aerodynamic drag, aerodynamic noise, radar emission, radar cross section, IR emission.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is an isometric bottom view of an aircraft pylon in accordance with an example of the presently disclosed subject matter;

FIG. 2 is an isometric bottom view of the aircraft pylon of FIG. 1, in the closed position;

FIG. 3 is an isometric bottom view of an aircraft having the pylon of FIG. 1 mounted thereon; and,

FIG. 4 is an isometric top view of an aircraft having the pylon of FIG. 1 mounted thereon.

### DETAILED DESCRIPTION OF EMBODIMENTS

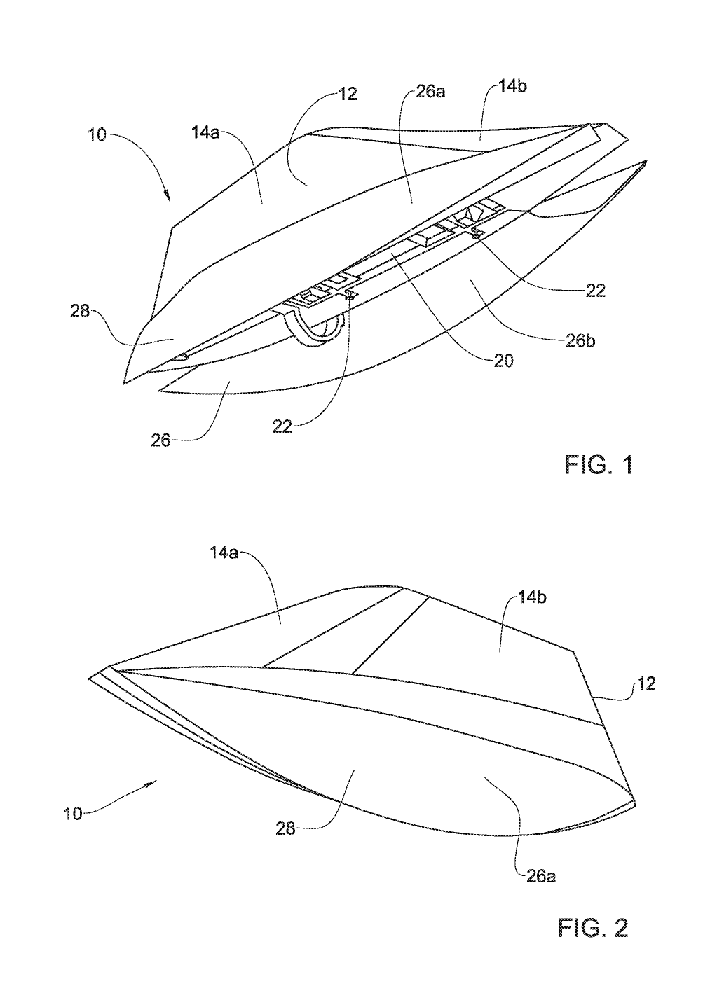

FIG. 1 shows an aircraft pylon 10, including a body 12 configured for mounting to an aircraft, for example to the bottom surface of a wing, or the fuselage thereof.

The body 12 includes an outer surface 14a configured with a shape optimized for various parameters, such as aerodynamic drag, aerodynamic noise, radar emission, IR emission, etc. The outer surface 14a can include for example a narrow portion 14b defined such that when the pylon is mounted on an aircraft the narrow portion is disposed in parallel with the traveling direction of the aircraft.

It is appreciated that the designing process of the body 12 and the outer surface 14a can include shape optimization methods, as known.

The body 12 further includes coupling member (not shown) for coupling thereof to an aircraft, the coupling means can be configured for a permanent mounting of the pylon, such as rivets, bolts, welding portions, etc. Alternatively, the coupling means can be configured for releasable mounting of the pylon, such that the pylon can be mounted to the aircraft when it is necessary to carry on the aircraft an external payload, such as an external fuel tank, and can be removed when the aircraft does not carry an external payload.

The body 12 further includes a suspension mechanism 20 mounted thereon and being configured for attaching thereto payload. The suspension mechanism 20 includes one or more securing elements 22 configured to be secured to corresponding securing elements provided on the payload. The suspension mechanism 20 can include a releasing mechanism (not shown) for an automatic releasing of the payload secured to the securing elements 22. This way, the payload, for example a drop tank, can be released by the aircraft operator while the aircraft is in the air, such as when the tank is empty.

It is appreciated that the body 12 of the pylon 10 can be configured such that the payload mounted thereon does not interfere with the operation of the aircraft. That is to say, the body is configured to distance the payload from the wing, or other portions of the aircraft, so as to clear the control surfaces thereof as well as to prevent undesired disturbance of the flow of air toward the wing.

In addition, it is appreciated that the disposition of the suspension mechanism 20 on the body 12 can be determined in accordance with the size of the payload, the shape of the outer surface 14a, the dimensions of the body 12, and the location on the aircraft on which the pylon is mounted. That is to say, the disposition of the suspension mechanism 20 can be determined so as to allow securing payload thereto in a manner which will minimize the effect thereof on the operation of the aircraft.

The pylon 10 further includes a moving door 26 configured for selectively covering and uncovering at least a part of the suspension mechanism 20. The moving door 26 can include an outer surface 28 having a shape optimized to have pre-determined exterior interaction, such as a pre-determined aerodynamic drag, aerodynamic noise, radar emission, IR emission, etc.

It is noted that the term exterior interaction as referred to in this application can include any exterior parameter which effects the operation of the aircraft in view of the intended use thereof, with respect to the exterior environment. It is appreciated that the exterior interaction may differ depending on the aircraft, for example, a slight aerodynamic drag caused by a pylon may not affect the operation of an aircraft equipped with a powerful jet engine this is in comparison to a small aircraft. Similarly, considering the IR emission of a pylon body in a commercial aircraft may not be necessary. Thus, the exterior interaction can include any parameter which is required for the operation of the aircraft considering the intended use thereof.

The outer surface 28 can be configured such that the exterior interaction thereof conforms to corresponding exterior interaction of the body 12, or the outer surface 14a of the body. That is to say, if for example the outer surface 14a of the body 12 is configured with a predetermined magnitude of aerodynamics drag, the outer surface of the moving door 26 is configured such that it forms a similar magnitude of aerodynamics drag. This way, the body and the moving door form together a substantially homogenous structure which provides similar exterior interaction as required.

It is appreciated that the designing process of the moving door 26 and the outer surface 28 thereof can include the same shape optimization method as in the designing process of the out surface 14a of the body. In fact, the shape optimization process of both the body 12 and the moving door 26 can take into consideration similar parameters.

It is further appreciated that the shape optimization process of the body 12 and the moving door 26 can be carried out as part of the shape optimization process of the entire aircraft. Thus, the exterior interaction of the outer surface 28 of the moving door 26 can conform to the corresponding exterior interaction of the outer surface 14a of the body 12, as well as to the exterior interaction of the aircraft.

For example, if the aircraft is designed with a shape having a predetermined radar emission level, or radar cross section, the outer surface 14a of the body 12 as well as the outer surface 28 of the moving door 26 can be designed such the radar emission level or the radar cross section thereof is conformed to that of the aircraft. This way, when the door 26 covers the suspension mechanism 20, the aircraft can operate as a homogenous body even when a pylon is mounted thereon.

It is appreciated that the moving door 26 can be configured to cover at least a part of the of the suspension mechanism 20, such that the shape and elements thereon do not cause an exterior interaction different than that of the outer surfaces of the body 12 and the moving door 26. That is to say, since the suspension mechanism 20 may for example cause an undesired aerodynamic drag, the moving door 26 is configured such that the suspension mechanism 20 is covered in a way that the aerodynamic drag is precluded. Accordingly, the moving door 26 can be configured to cover the entire suspension mechanism 20 or portions thereof which form an undesired exterior interaction. For example, if a rear portion of the suspension mechanism 20 faces a direction which is opposite to the traveling direction of the aircraft, the rear portion may not cause any undesired aerodynamic drag. Thus, the moving door 26, in this example, can be configured to cover only the front or side portions of the suspension mechanism 20.

As explained hereinabove the required exterior interaction of the pylon and the moving doors depends on the intended use of the aircraft, thus determining which parts of the suspension mechanism 20 are to be covered may depend on the intended use of the aircraft, as well.

According to the illustrated example the moving door 26 includes two corresponding wings 26a and 26b, configured to pivot along the length of the pylon 10, such that in the closed position, each wing cover substantially half of the width of the suspension mechanism 20. In the open position, on the other hand, each of the wings 26aand 26b is pivoted sidewardly, such that a payload can be disposed therebetween and be secured to the suspension mechanism 20.

It is appreciated that according to other examples, the moving door can be a single door pivoting along any side of body 12 of the pylon 10, or can be a sliding door, configured to slide in any direction such that the suspension mechanism 20 is selectively covered or uncovered. According to the further example, the moving door can be a folding door configured to fold away from the suspension mechanism 20 such that the payload can be secured thereto.

According to an example the moving door can be configured to cover, in the closed position, the suspension mechanism 20 together with the payload secured thereto. For example, the suspension mechanism 20 can be configured to secure thereto a small device, such as a camera, and the moving door can be configured with an outer surface which allows closing the door even when the device is secured to the suspension mechanism. This way, the door 26 can be opened to allow utilizing the device mounted on the suspension mechanism 20, and can be closed when the device is not in use so as to optimize the outer surface of the pylon, and to avoid undesired external interaction of the device or the suspension mechanism 20.

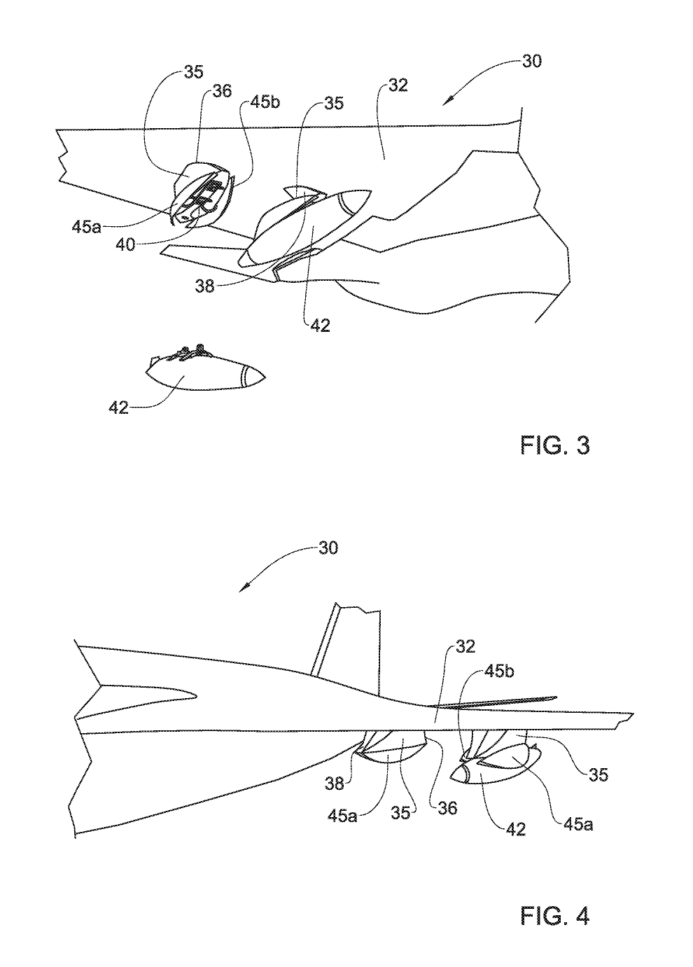

Reference is now made to FIGS. 3 and 4, an aircraft 30, can include one or more pylons 35 mounted thereon, for example on the bottom surface of the wing thereof 32. The pylons 35 include a body 36 having an outer surface 38, a suspension mechanism 40 mounted on a bottom surface 39 of the body 36 and configured to secure thereto a payload, here illustrated as an external drop tank 42. The suspension mechanism 40 is configured to automatically release the external drop tank 42.

The pylons 35 further includes a pair of moving doors 45a, 45b configured to pivot along the length of the pylon between a closed position in which the suspension mechanism 40 is covered, and an opened position in which the suspension mechanism 40 is uncovered allowing thereby to secure the external drop tank 42 thereto.

When the suspension mechanism 40 is not in use, and no payload is secured thereto, the moving doors 45a, 45b are pivoted to the closed position thereof, thereby covering the suspension mechanism 40 an providing an optimized outer surface to the pylon such which conforms with the outer shape of the aircraft 30. The moving doors 45a, 45b can be configured to automatically shift to the closed position thereof when the payload is released from the suspension mechanism 40. Thus, when the drop tank 42 is released the moving doors 45a, 45b automatically close thereby covering the suspension mechanism 40 and providing the pylon 35 with a homogenous outer surface optimized in accordance with the required parameters of external interaction.

Accordingly, the aircraft 30 and the pylon 35 can be selectively utilized in a first mode and in a second mode. In the first mode, the moving doors 45a and 45b are opened allowing thereby to secure the payload thereto, for example a drop tank 42. In the second mode, when the pylon 35 is not is use, for example when the drop tank 42 is dropped, the moving doors 45a and 45b are closed, thereby covering the suspension mechanism 40 and forming thereby an optimized homogenous shape together with the pylon body.

It is appreciated that in the first mode of the aircraft 30, when the moving doors 45a and 45b are opened, the shape of the entire aircraft including the pylon 35 and the payload secured thereto, may not have an optimized shape with regards to exterior interactions, as explained herein above. In the second mode, however, when the moving doors 45a and 45b are closed, the shape of the entire aircraft 30 including the pylon 35 provide an optimized shape with regards to the desired exterior interactions. Thus, in order to allow providing the aircraft 30 with and optimized shape, the moving doors 45a and 45b can be closed without having to remove the pylon 35 therefrom. It is further appreciated the aircraft operator can release the payload during the flight thereby, and shift the moving doors to the closed position, thereby shifting the aircraft to the second mode thereby optimizing the flight parameters. Due to the shape optimization provided by the external configuration of the pylon and the moving doors, in the second mode, the aircraft can achieve the same exterior interaction such as provided by similar aircrafts which are not provided with a pylon.

Those skilled in the art to which the presently disclosed subject matter pertains will readily appreciate that numerous changes, variations, and modifications can be made without departing from the scope of the invention, mutatis mutandis.

1-24. (canceled)

25. An aircraft pylon designed for carrying an external payload, the aircraft pylon comprising:
a body for mounting to an aircraft;
a suspension mechanism mounted on the body and being configured for selectively attaching thereto and releasing the external payload; and
a moving door configured for selectively shifting between a closed position in which at least part of the suspension mechanism is covered, and an open position in which the suspension mechanism is uncovered;
wherein releasing the external payload when the moving door is in the open position facilitates shifting the moving door to the closed position.

26. The aircraft pylon of claim 25 wherein the moving door includes an outer surface having a shape optimized to have predetermined exterior interaction conforming to a corresponding exterior interaction of the body.

27. The aircraft pylon of claim 26 wherein the corresponding exterior interaction of the body conforms to an exterior interaction of the aircraft.

28. The aircraft pylon of claim 26 wherein the exterior interaction includes at least one member selected from the group including aerodynamic drag, aerodynamic noise, radar emission, and IR emission.

29. The aircraft pylon of claim 26 wherein the exterior interaction includes at least one parameter exterior to the aircraft that effects operation of the aircraft in view of an intended use thereof.

30. The aircraft pylon of claim 25, further comprising coupling means configured for releasably mounting of the body to the aircraft.

31. The aircraft pylon of claim 25 wherein the suspension mechanism includes securing elements configured to be secured to a corresponding securing elements provided on the external payload.

32. The aircraft pylon of claim 25 wherein the moving door is configured to cover at least portions of the suspension mechanism from an undesired exterior interaction.

33. The aircraft pylon of claim 25 wherein the moving door is configured to cover the entire suspension mechanism.

34. The aircraft pylon of claim 25 wherein the moving door includes two wings configured to pivot along the body.

35. The aircraft pylon of claim 25 wherein the moving door includes a single door pivotable along the body.

36. The aircraft pylon of claim 25 wherein the moving door includes a sliding door configured such that the suspension mechanism is selectively covered or uncovered.

37. The aircraft pylon of claim 25 wherein the moving door includes a folding door configured to fold away from the suspension mechanism such that the external payload can be secured thereto.

38. An aircraft comprising an aircraft body and the aircraft pylon according to claim 25.

39. The aircraft of claim 38 wherein:
the aircraft body is configured with an optimized shape having a predetermined exterior interaction; and
the moving door includes an outer surface having a shape optimized to have a predetermined corresponding exterior interaction conforming to the exterior interaction of the aircraft body.

40. The aircraft of claim 39 wherein the exterior interaction includes at least one member selected from the group including aerodynamic drag, aerodynamic noise, radar emission, and IR emission.

41. The aircraft of claim 38 having a first mode, wherein the aircraft body together with the body of the aircraft pylon provide an optimized shape with regard to the exterior interactions when the moving door is in the closed position.

42. A method for optimizing a shape of an aircraft body, the method comprising:
optimizing a shape of an aircraft body in view of an intended use thereof;
selecting a pylon having a pylon body for mounting to the aircraft body, selecting a suspension mechanism for mounting on the pylon body being configured for attaching thereto a payload;
selecting a moving door configured for selectively shifting between a closed position in which at least part of the suspension mechanism is covered, and an open position in which the suspension mechanism is uncovered;
wherein releasing the payload when the moving door is in the open position facilitates shifting the moving door to the closed position; and
optimizing, in view of the intended use of the aircraft, the shape of the pylon body and the moving door in the closed position.

43. The method of claim 42 wherein:
optimizing the shape of the aircraft body includes selecting an outer surface configured for a predetermined exterior interaction; and
optimizing the shape of the pylon body and the moving door includes selecting an outer surface configured for a corresponding predetermined exterior interaction conforming to the exterior interaction of the aircraft body.

44. The method of claim 43 wherein the exterior interaction is selected from the group including aerodynamic drag, aerodynamic noise, radar emission, and IR emission.
